(19) United States
(12) Patent Application Publication
(10) Pub. No.: US 2009/0271611 A1
(43) Pub. Date: Oct. 29, 2009

(54) SYSTEM AND METHOD OF MANAGED CONTENT DISTRIBUTION

(75) Inventor: Erik M. ROLL, New York, NY (US)

Correspondence Address: BLANK ROME LLP, WATERGATE, 600 NEW HAMPSHIRE AVENUE, N.W., WASHINGTON, DC, 20037, US

(73) Assignee: Proscape Technologies, Inc., Horsham, PA (US)

(21) Appl. No.: 12/429,053

(22) Filed: Apr. 23, 2009

Related U.S. Application Data
(60) Provisional application No. 61/047,223, filed on Apr. 23, 2008.

(51) Int. Cl. G06F 21/20; G06F 15/16; H04L 9/00; G06F 3/048

(52) U.S. Cl. 713/150; 715/733; 726/4; 709/240

(57) ABSTRACT

A system and method of managing content distribution is disclosed. The system and method comprise at least one first user interface for publishing content to one or more web servers, at least one application server for generating a set of instructions describing one or more parameters for downloading said content, and at least one second user interface for receiving said set of instructions from the application server and downloading said content, wherein the at least one second user interface uses said set of instructions to determine which of the one or more web servers the content should be downloaded from.

### CROSS-REFERENCE TO RELATED APPLICATIONS

This application claims the benefit of U.S. Provisional Application Ser. No. 61/047,223, filed Apr. 23, 2008, the contents of which are incorporated herein by reference.

### FIELD OF THE INVENTION

The present invention generally relates to a system and method of content distribution. More particularly, the present invention relates to a system and method for efficiently managing content distribution across communications networks.

### BACKGROUND OF THE INVENTION

The internet has become the most common mechanism of information dissemination in today's society. The World Wide Web (WWW or Web) application of the internet provides functionality for users to post content to servers for dissemination to a plurality of clients. A server is a computer that performs tasks at the command of another computer, and a client is a computer that issues such commands. Servers and clients form the network across which the information is disseminated.

Originally, all content was retrieved over the internet using “pull” technology. Pull technology is a form of network communication in which a request for content is originated at the client and is responded to by the server. This is sometimes called a query model. Using pull technology, a user, acting as a client operator, typically utilizes a Web browser to locate content of interest by browsing server content or using a search engine to query specific content. After the content of interest is located, the user must retrieve that content from the associated server by, for example, clicking on an icon or hyperlink displayed in the Web browser. Due to the expansiveness and continuously growing amount of content available on the internet, it is often difficult for a user to locate content efficiently.

In addition to the problem of requiring a user to actively sort through a vast amount of content until the user locates the exact content of interest, pull technology also presents various other drawbacks. For example, if the content the user wants to retrieve can only be accessed via a slow network connection, then the user will experience a prolonged waiting period or may even be notified that the content is not available. In addition, even where the network connection is not comparatively slow, most network connections are limited to a specific amount of bandwidth corresponding to the amount of data that can be communicated across that connection in a specific amount of time (e.g., bits/second). Thus, as more users attempt to simultaneously retrieve the same content from a server, the amount of bandwidth decreases, which in turn increases the total amount of time required for each user to retrieve that content. In response to the vast amount of information a typical internet user must sort through to locate content of interest and to avoid the long waiting times that can occur when retrieving content from slow or overloaded network connections, an alternative method for obtaining content of interest was developed—“push” technology.

Push technology, or webcasting, is a form of network communication in which a server automatically sorts through the content on its own database(s) according to pre-specified user-defined filter criteria and sends the relevant content to the client at an appropriate time. This is sometimes call a publish/subscribe model. To use push technology, a user must typically download special client software that acts independently of or in conjunction with the user's Web browser to receive the content being pushed to the user. Or, in the alternative, the user may access a dynamically generated web page or receive an e-mail message that contains/lists the retrieved content of interest.

To establish the filter criteria by which a server locates, retrieves, and ranks content of interest for a user via push technology, the user typically creates a profile or preferences that define the content of interest sought by that user. Those predefined profiles and preferences are typically limited to specific information channels rather than being applied across the entire internet, which helps significantly narrow the results of a query to the exact content of interest sought by the user. For example, a profile or preference that seeks current news stories on a specific topic would be limited to servers that carry news.

In addition to cutting down on the large amount of irrelevant information that a user must sort through to locate content of interest, push technology seeks to offer improvements over pull technology by allowing the server to determine the appropriate time and manner of distributing data to each client. When the content is being sent to a client computer for download instead of being published to a dynamically generated web page or sent via an e-mail message, the server may try to push that content when the client computer is idle or when the server has the most available bandwidth. The server can balance its content distributions across an entire list of clients maintained by that server. That functionality helps to avoid the long waiting times that can occur when retrieving content from slow or overloaded network connections using pull technology.

Although push technology addresses some drawbacks of pull technology, it has its own drawbacks. For example, the profiles and preferences used in push technology do not always provide the most relevant content because certain content of interest does not easily fit into the types of categories defined by profiles and preferences. In addition, because the server determines when to distribute content to each client, the user must wait for the server to distribute content such that content may not always be the most up-to-date. Moreover, if the client computer is not connected to the network at the time content is sent, it will not receive the content. And, if the server does not determine that it is appropriate to send updated content until after another update has occurred, a user may miss a set of updated content entirely.

Accordingly, there is a need for a low cost system and method of efficiently managing content distribution over a computer network that avoids returning overly broad content as is typical in pull technology, avoids overly narrow search criteria as is typical in push technology, avoids long waiting times that can occur when pulling content from slow or overloaded network connections, and prevents a user from missing content updates.

### SUMMARY OF THE INVENTION

Accordingly, to solve at least the problems and/or disadvantages described above, and to provide at least the advantages described below, a non-limiting object of the present invention is to provide a system and method of content distribution comprising at least one first user interface for publishing content to one or more web servers, at least one application server for generating a set of instructions describing one or more parameters for downloading said content, and at least one second user interface for receiving said set of instructions from the application server and downloading said content, wherein the at least one second user interface uses said set of instructions to determine which of the one or more web servers the content should be downloaded from.

Those and other objects of the invention, as well as many of the intended advantages thereof, will become more readily apparent when reference is made to the following description, taken in conjunction with the accompanying drawings.

### BRIEF DESCRIPTION OF THE DRAWINGS

FIG. 1 is a diagram illustrating the infrastructure of a communications network according to a non-limiting exemplary embodiment of the present invention; and

FIG. 2 is a flow chart illustrating the functional steps of a content distribution process according to a non-limiting exemplary embodiment of the present invention.

### DETAILED DESCRIPTION OF THE EXEMPLARY EMBODIMENTS

The system and method of the present invention provide all of the advantages of push technology and pull technology while eliminating at least the disadvantages discussed above. For example, the system and method of the present invention eliminate the problems associated with retrieving large volumes of content by allowing content managers to pre-define channels through which remote users retrieve data. Those channels eliminate the problems of slow and/or overloaded network connections by balancing the loads of content pulls across a plurality of servers within the channel. And, the system and method of the present invention eliminate the problem of missed content pushes by allowing the users to pull content on demand from the plurality of servers. Moreover, the system and method of the present invention can be employed using a redundant array of internet-connected low cost servers without requiring that special software reside on those servers, which provides redundancy, scalability, and secure distribution using public servers. Thus, the present invention also provides an economical solution to at least the disadvantages discussed above.

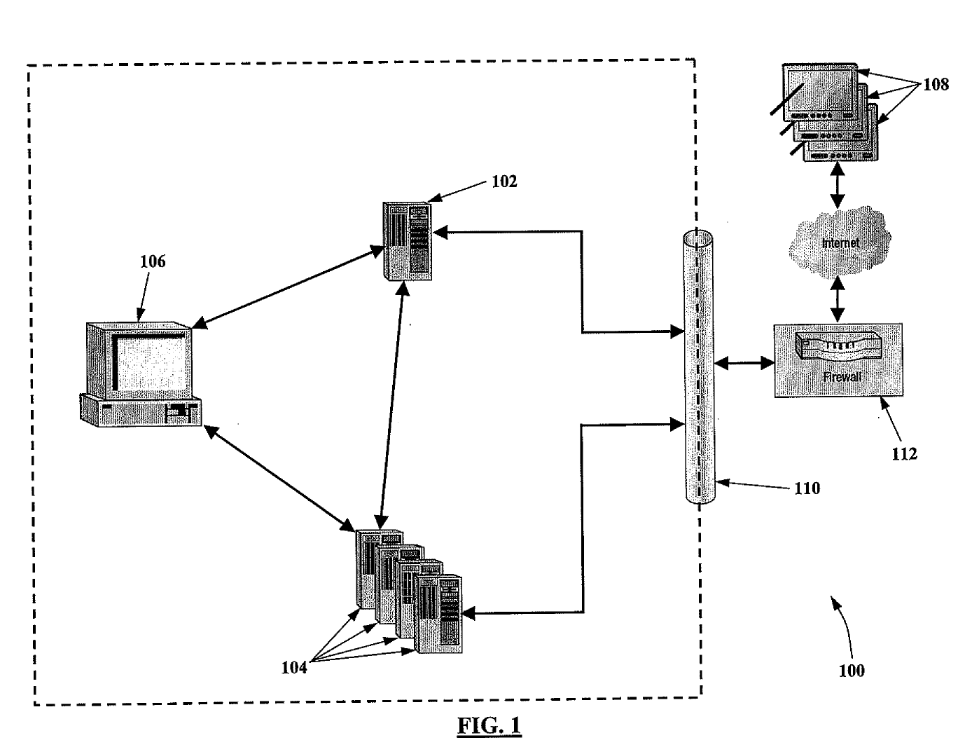

Reference will now be made in detail to non-limiting embodiments of the present invention by way of reference to the accompanying drawings, wherein like reference numerals refer to like parts, components, and structures. Turning to the drawings, FIG. 1 illustrates an exemplary non-limiting embodiment of the infrastructure of a network 100 over which the present invention can be employed. The network 100 includes at least one content management server 102, a plurality of content distribution servers 104, at least one content manager interface 106, and a plurality of remote user interfaces 108.

The content management server 102, content distribution servers 104, and content management device 106 are connected to each other over a Local Area Network (LAN) 110, which may be located behind a firewall 112 to provide security from unauthorized internet access. The remote user interfaces 108 are located outside of the LAN 110 and are connect to the content management server 102 and content distribution server 104 over substantially any suitable secured computer network (e.g., a Virtual Private Network (VPN) using a secured broadband connection, such as Digital Subscriber Line (DSL), cable modem, wireless link, or other high-speed connection). The VPN implements an authentication mechanism for users to gain access and provides secure communications between the remote user interfaces 108 and the content management server 102 and content distribution server 104 after the user gains access. Communications between the remote user interfaces 108 and the content management server 102 and the content distribution server 104 may also be encrypted to provide additional security. And, although in the exemplary embodiment illustrated in FIG. 1 the content distribution servers 104 are located within the LAN 110, those servers may also be provided outside of the LAN 110 and connected to the other components of the network 100 via any suitable secured connection.

The content management server 102 includes distribution management software applications that provide functionality for controlling users and groups, including their accesses and rights, and content distribution rules. That software may include content distribution software, such as Proscape Technologies, Inc.'s Application Server software, for controlling when content is pushed to or pulled from the other components of the network 100. Although only one content management server 102 is illustrated in FIG. 1, a plurality of content management servers 102 may be provided in a clustered or load-balanced environment as the number of users or groups accessing the network 100 increases, or as data traffic increases.

The content distribution servers 104 include standard web server software applications, such as Microsoft Corp.'s MICROSOFT brand web server applications (e.g., Internet Information Services (IIS)) or Linux web server applications (e.g., Apache), that provide functionality for accepting Hypertext Transfer Protocol (HTTP) and File Transfer Protocol (FTP) requests from various clients and for providing an HTTP or FTP response to those clients. The HTTP response may consist of a Pre HyperText Processor (PHP) enhanced HyperText Markup Language (HTML) document (i.e., a dynamic web page), and the FTP response may consist of a raw image file, JPG images, or any other type of document defined by Multipurpose Internet Mail Extension (MIME) types. Using that functionality, the content distribution servers 104 are configured to receive content pushed from the content manager interface 106 or the remote user interfaces 108 and to have that content pulled to the content management server 102 or the remote user interfaces 108. The content distribution servers 104 differ from the content management server 102, the content manager interface 106 and the remote user interfaces 108 primarily in that the content distribution servers 104 do not require that specific distribution management software applications be installed thereon. Instead, all that needs to reside on the content distribution servers 104 are standard web server software applications, such as those described above.

The content distribution servers 104 do not require that specific distribution management software applications be installed thereon because all of the processing of content distribution is shared by the content management server 102, the content manager interface 106, and the remote user interfaces 108. Thus, the content distribution servers 104 function as “dumb” servers within the network 100, and data is either pushed to those servers 104 or pulled from them. Accordingly, the content distribution servers 104 of the present invention can be provided as a redundant array of internet-connected low cost servers (e.g., a bank of “dumb” FTP servers). Not only is that configuration economical, it also enables rapid and easy scaling, redundancy, and secure distribution using public servers. Accordingly, a user can cheaply and efficiently create a large pool of content distribution servers 104 over which the bandwidth demands of content pulls and pushes can be balanced to prevent server overload and excessive wait times during content distribution.

A content distribution server 104 can be configured by merely using standard web server software applications to identify the server type (e.g., WINDOWS brand server or Linux Server), the file transfer protocol for the content (e.g., FTP, FTPS, HTTP, and HTTPS), the uniform resource locators (URLs) for content (e.g., FTP:// . . . , FTPS:// . . . , HTTP:// . . . , and HTTPS:// . . . ), and user names and passwords. The type of server determines the operating system run on that content distribution server 104. The file transfer protocol determines the protocol that the content distribution server 104 will use to transfer content over the network 100. The URLs indicate the global address of content and other resources on the network 100. And, the user names and passwords are associated with each user's access rights on the network 100. Preferably, the content distribution server 104 is configured to receive entire files from the content manager interface 106 and the remote user interfaces 108 using the FTP or FTPS protocol, and is configured to transfer web page contents to the remote user interfaces 108 for viewing using the HTTP or HTTPS protocol.

The content manager interface 106 includes distribution management software applications that provide functionality for a user acting as a content manager to create content, organize content, and distribute that content across the network 100. That software may include a computer operating system, such as Microsoft Corp.'s WINDOWS brand computer operating system, for providing a graphical user interface with the various software applications on the content manager interface 106. That software may also include a content creation software, such as Adobe Systems Inc.'s FLASH brand content creation software, for assembling rich media content and presentations. And, that software may include a publishing module, such as Proscape Technologies, Inc.'s PUBLISHMANAGER module, for creating content distribution channels and facilitating the distribution of content to other system users through those content distribution channels. The content manager interface 106 also includes its own local storage device for storing content thereon. Accordingly, the content manager interface 106 provides a centralized interface for a user acting as a content manager to create content, organize content, and distribute that content to other users across the network 100. The content manager interface 106 may also be used to pull content from the content distribution servers 104.

The remote user interfaces 108 include distribution management software applications that provide functionality for receiving content, displaying content, capturing content, and submitting content. That software may include a tablet operating system, such as Microsoft Corp.'s WINDOWS brand tablet operating system, for providing a graphical user interface with the various software applications on the content management server 102. That software may also include content management software, such as Proscape Technologies, Inc.'s Closed Loop Marketing software, for managing an enterprise-wide repository of content in a single integrated Web environment, capturing content in real time, receiving and distributing content across a plurality of content distribution channels, and displaying that content. The remote user interfaces 108 also include their own respective local storage device for storing content thereon.

The remote user interfaces 108 may be provided as mobile computers, such as Tablet computers, that are connected to the network by a secured Wireless Local Area Network (WLAN) or other secured wireless network connection. Accordingly, the user interfaces may also include wireless networking and mobility technology, such as Intel Corp.'s CENTRINO brand mobile technology processors, and associated mobilized software components. The mobilized software components provide capable offline content management, allowing the applications on the remote user interfaces 108 to provide a consistent user experience regardless of network connection status. For example, when connected, users can retrieve content from the content distribution servers 104 directly or via a log-on account. And, when disconnected, users can rely on the content stored on the local storage device of the remote user interfaces 108. Accordingly, the remote user interfaces 108 provide a highly mobile interface for remotely receiving, displaying, capturing, and distributing content via the network 100.

When implemented on the network 100 of FIG. 1, the present invention provides novel functionality for distributing unique sets of content to various users at the plurality of remote user interfaces 108. That novel functionality combines push technology and pull technology in a manner that substantially eliminates the disadvantages associated with each technology while capitalizing on the advantages of each. And, by utilizing a redundant array of internet-connected low cost servers as the content distribution servers 104, the present invention also eliminates those disadvantages in an economical manner.

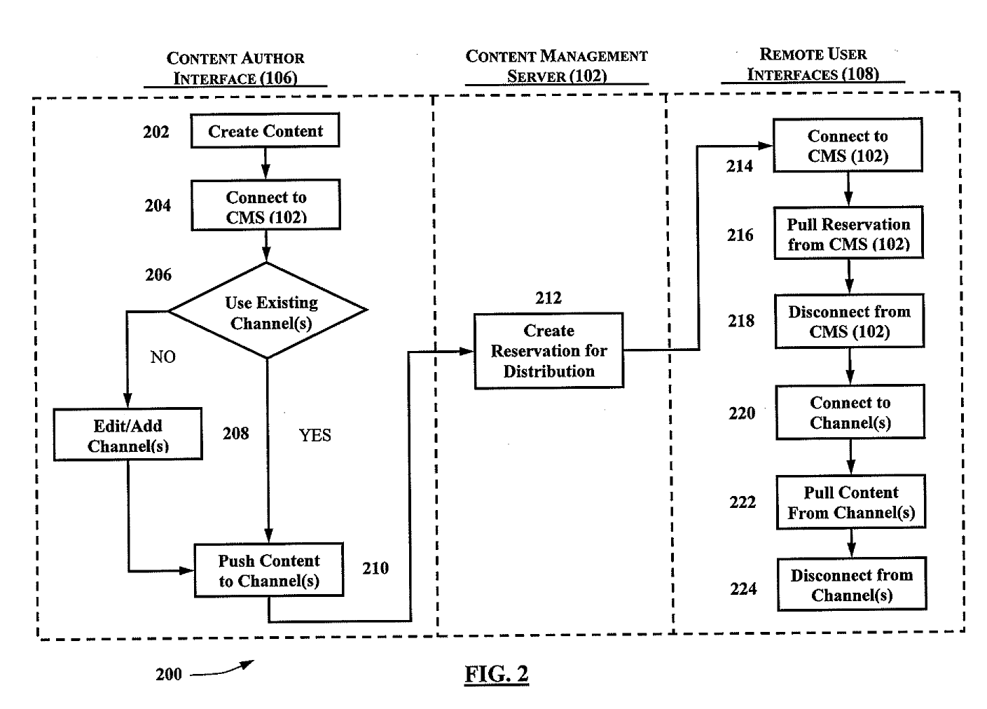

FIG. 2 illustrates a non-limiting example of a content distribution process 200 according to the present invention that minimizes waiting times when pulling content. The dashed lines in FIG. 2 illustrate where in the network 100 each of the steps 202-224 occurs (e.g., the content management servers 102, the content manager interface 106, or the remote user interfaces 108). The content distribution process begins at step 202, where a user acting as a content manager creates content at the content manager interface 106. The content created at the content manager interface 106 may include rich media files or data files. That content can also already exist on the local storage device of the content manager interface 106 or it can be downloaded to the content manager interface 106 from another source.

At step 204, the content manager uses the content manager interface 106 to connect and authenticate to the content management server (CMS) 102 via a secure internet connection. That functionality is provided using authentication protocol, such as Microsoft Corp.'s integrated WINDOWS brand authentication protocol, to assure that sensitive content is not distributed to or accessed by the wrong person. The authenticated connection to the content management server 102 may occur automatically, or by the user being prompted to input a user name and password.

After the content manager has made a secure connection to the content management server 102 at step 204, the content manager decides which “channel” it wants to distribute content through. A channel is a list of content distribution servers 104 for hosting content with pre-defined parameters governing user accesses to that content. At step 206, the content manager decides whether to use an existing distribution channel, edit an existing distribution channel, or add a new distribution channel for use in distributing content. If the content manager elects to edit an existing distribution channel or create a new distribution channel, the content manager edits or adds that distribution channel at step 208.

The content manager edits or adds a distribution channel using the publishing module on the content manager interface 106 in conjunction with the content distribution software applications on the content management server 102. Using those software applications, the content manager can create a new distribution channel at step 208 by naming that channel and adding at least one content distribution server 104 to the channel. With a new distribution channel added or an existing distribution channel selected to edit at step 208, the content manager can add or remove content distribution servers 104 from the channel, add or remove users and groups with access to that channel, and change the access rights of each user with access to that channel. By assigning a plurality of content distribution servers 104 to a channel and giving only specific user access rights to the content on those servers, the present invention is able to balance loads across those servers to minimize bandwidth constraints while providing redundancy, scalability, and secure distribution.

After a distribution channel has been configured, the content manager pushes the selected content to all of the content distribution servers 104 in the distribution channel at step 210 by merely selecting the content that the content manager desires to distribute over that channel. When the content manager is using or editing an existing distribution channel, the content manager can either select additional content to add to the content already on that channel, or the content manager can de-select content already on that channel so that the de-selected content is no longer available to the users on that channel. Accordingly, the content manager can replace the content on a distribution channel with entirely new content, can modify the content on the distribution channel by adding to or removing existing content, and can remove all content from the distribution channel.

The content pushed to the content distribution servers 104 in the selected distribution channel is encrypted to provide additional security. And, after selecting the content to be pushed to or removed from the content distribution servers 104, the content manager can either immediately transfer the selected content to/from the content distribution server, or choose a later date/time at which the content will be transferred to/from the content distribution servers 104. That functionality allows a content manager to determine exactly what content is available for distribution to which users and at what time that content becomes available or unavailable.

After a content manager has pushed the selected content to the content distribution servers 104, at step 212 a “reservation” is created at the content management server 102. The content management server 102 creates the reservation using the data keyed at the content manager interface 106 relating to the content pushed to the content distribution servers 104, which it receives via a network connection with the content manager interface 106.

The reservation generated by the content management server 102 includes a set of data for the remote user interfaces 108 to use to manage pulling content from the content distribution servers 104. The reservation identifies the distribution channel(s) and content on each channel, the content distribution servers 104 on the distribution channel from which the authorized users can pull content, the temporal instructions for determining when content can be pulled from those content distribution servers 104, and details regarding the content stored on those content distribution servers 104. The reservation may also include any other parameters the content manager desires to impose. Accordingly, the reservation provides a small packet of information that can be pulled from the content management server 102 without using a significant amount of bandwidth, which helps eliminate server overload even when a large number of users are pulling reservations at the same time. The reservation also may be encrypted to provide additional security.

At any time after a reservation has be generated at the content management server 102, at step 214 a remote user interface 108 connects to the network 100 and polls for a secured connection to the content management server 102. That connection is secured and authenticated as described for step 204. After connecting to the content management server 102, at step 216 the remote user interface 108 pulls the reservation from the content management server (CMS) 102. Then, at step 218, the connection is terminated immediately after the reservation is pulled from the content manager server 102. Combined with the small size of the reservation that is pulled from content management server 102, such abbreviated sessions of connectivity with the content management server 102 help further cut down on bandwidth constraints and transaction processing-intense demands.

Based on the reservation pulled from the content management server 102, at step 220 the remote user interface 108 will poll for a secured connection to the content distributions servers 104 on the distribution channels to which the user of the remote user interface 108 has access. If the content on the content distribution servers 104 was not scheduled to be updated until a later date/time, the remote user interface 108 will not begin polling for a secured connection to the content distribution servers 104 until or after that date/time. That connection can also be secured and authenticated as described for step 204.

By allowing individual content pulls to be scheduled differently, a large number of remote user interfaces 108 with access to a specific distribution channel can be scheduled to pull content from the content distribution servers 104 in a staggered manner to prevent overloading the content distributions servers 104, which helps eliminate delays from bandwidth overload. Moreover, each remote user interface 108 can have access to multiple distribution channels, and content pulls can be balanced by channel in a similar manner.

After the remote user interface 108 is connected to the appropriate distribution channel, at step 222 it pulls content from the content distribution servers 104 on that channel and deciphers the content in accordance with the data in the reservation. The distribution management software applications on the remote user interface 108 also include functionality for using the data in the reservation to balance content throughput dynamically at runtime by, for example, determining the fastest distribution servers 104 in the distribution channel and using them over slower ones based on the transfer speeds of each content distribution server 104. It also includes failover capability for switching between servers if one or more of the content distribution servers 104 fails. That process is optimized to balance the load across the content distribution servers 104 in a manner that maximizes the download speed and reliability of the remote user interfaces 108.

The remote user interfaces 108 also include optimization functionality for minimizing the amount of content pulled from the content distribution servers 104 by analyzing the data in the reservation to determine what content has already been pulled to that remote user interface 108 and pulling only the content not already resident. The remote user interfaces 100 also include byte-level check-point restart functionality so that it at any time during the pull of content, the connection is severed, the remote user interfaces 108 will begin downloading again at the point of drop on a byte level on the next subsequent connection. The remote user interfaces 108 also review pulled content for corruption and will pull content as required to replace any corrupt content on that remote user interface 108.

Then, immediately after the remote user interface 108 has pulled all of the associated content from the channel(s) to which it has access, at step 224 the remote user interface 108 disconnects from the content distribution servers 104, further reducing demand on bandwidth. That end-to-end transfer of content is used to synchronize the plurality of remote user interfaces 108 so they each contain the most recently updated content on a distribution channel.

The content distribution servers 104 can be used in a similar manner to transfer content from the remote user interfaces 108 to the content management server 102. For example, content such as usage data captured at the remote user interfaces 108 can be pushed to one or more content management server 102. Such content pushes can be distributed over a plurality of content distribution servers 104 to accommodate a large number of simultaneous content pushes or to provide failover capability if one or more of the content distribution servers 104 fails. That content can then be pulled from the content distribution servers 104 by the content management server 102 and harvested for analysis. The content distribution servers 104 used to host content pushed from the remote user interfaces 108 can be different than the content distribution servers 104 used to host content pulled by the remote user interfaces 108.

In addition, the content distribution servers 104 and the remote user interfaces 108 also include functionality for managing content at the individual file level to support optimization through content reuse. For example, specific content, such as a presentation, may exist in each of ten channels to which a remote user interface 108 has access. In that situation, only one instance of the presentation will be pulled for storage on the local storage device of the remote user interface 108. That functionality not only provides additional efficiency, it also allows overlapping content to be updated for all channels when that content is updated at only one of the ten channels. Accordingly, a user does not have to go into every channel to change overlapping content whenever the user wants to update that content on multiple channels.

By employing functionality and a network infrastructure such as those described above, the present invention provides managed content distribution that overcomes the disadvantages of both push and pull technology while capitalizing on their respective advantages. The present invention avoids long waiting times that can occur when pulling content from slow or overloaded network connections by creating a small packet of information—a reservation—that is pulled from the content management server 102 and used to schedule larger content pulls that are efficiently distributed across a redundant array of internet-connected low cost servers—the content distribution servers 104. And, the present invention prevents a user from missing a content push when the user is off line because the content is pushed to an intermediary server—the content distributions servers 104—that is always on line where it can be pulled on demand by the user whenever the user gets back on line. Accordingly, the present invention provides a novel system and method of content distribution, which is particularly suited for synchronizing content with a large number of remote user interfaces 108 from a central location.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A content distribution system comprising:
at least one first user interface for publishing content to one or more web servers;
at least one application server for generating a set of instructions describing one or more parameters for downloading said content; and
at least one second user interface for receiving the set of instructions from the application server and downloading the content from the one or more web servers, the at least one second user interface using the set of instructions to determine which of the one or more web servers the content should be downloaded from.

2. The content distribution system of claim 1, wherein
content is either pulled from the one or more web servers or pushed to the one or more web servers so the one or more web servers may be provided as a redundant array of internet-connected servers.

3. The content distribution system of claim 1, wherein
at least a portion the content is encrypted and the set of instructions includes parameters for use by the at least one second user interface in deciphering the encrypted content downloaded from the one or more web servers.

4. The content distribution system of claim 1, wherein
the set of instructions includes parameters that define at least one of a date and a time when the at least one second user interface can download content from the one or more web servers.

5. The content distribution system of claim 1, wherein
at least one second user interface uses the set of instructions to determine which of the one or more web servers the content should be downloaded from by balancing content throughput dynamically at runtime by identifying which of the one or more web servers have the fastest transfer speeds and using them over ones with slower transfer speeds.

6. The content distribution system of claim 1, wherein
a first group of second user interfaces has access rights to content on a corresponding first group of one or more web servers and at least one second group of second user interfaces has access rights to content on at least one corresponding second group of one or more web servers.

7. The content distribution system of claim 1, wherein
the at least one first user interface executes computer-readable instructions to define a first group of one or more second user interfaces with access rights to content on a corresponding first group of one or more web servers and at least one second group of one or more second user interfaces with access rights to content on at least one corresponding second group of one or more web servers.

8. The content distribution system of claim 1, wherein
at least one second user interface has access rights to content on a first group of one or more web servers and content on at least one second group of one or more web servers,
at least a portion of the content on the first group of one or more web servers is the same as at least a portion of the content on the at least one second group of one or more web servers, and
the at least one second user interface executes computer-readable instructions to download only one instance of the content that is the same on the first group and second group(s) of one or more web servers.

9. The content distribution system of claim 1, wherein
the at least one first user interface, the one or more web servers, the at least one application server, and the at least one second user interface are interconnected with each other over a secure computer network.

10. The content distribution system of claim 1, wherein
the at least one second user interface comprises a tablet PC that wirelessly connects to the one or more web servers to download content.

11. A method for distributing content to one or more client devices, comprising the steps of:
creating at least one publication channel comprising one or more web servers with one or more parameters for downloading the content therefrom;
publishing the content to the one or more web servers on the at least one publication channel;
creating a set of instructions comprising at least one of the one or more parameters;
receiving said set of instructions at one or more user interfaces;
using the set of instructions to select which of the one or more web servers should be accessed for downloading the content; and
downloading the content from said selected one or more web servers to said one or more user interfaces.

12. The content distribution system of claim 11, wherein
content is either pulled from the one or more web servers or pushed to the one or more web servers so the web servers may be provided as a redundant array of internet-connected servers.

13. The content distribution system of claim 11, further comprising the step of
encrypting the content, wherein the set of instructions includes parameters for use by the one or more user interfaces in deciphering the encrypted content downloaded from the publication channel.

14. The content distribution system of claim 11, wherein
the set of instructions includes parameters that define at least one of a date and a time when at least one of the one or more user interfaces can download content from the publication channel.

15. The content distribution system of claim 11, wherein
the step of using the set of instructions to select which of the one or more web servers should be accessed for downloading the content includes balancing content throughput dynamically at runtime by identifying which of the one or more web servers have the fastest transfer speeds and selecting them over ones with slower transfer speeds.

16. The content distribution system of claim 11, wherein
the step of creating at least one publication channel comprises defining a first group of one or more web servers to which a corresponding first group of user interfaces has access rights and defining at least one second group of one or more web servers to which at least one corresponding second group of user interfaces has access rights.

17. The content distribution system of claim 11, wherein
the step of creating at least one publication channel is performed by at least one content manager interface that executes computer-readable instructions to define at least one first group of one or more user interfaces with access rights to content on a corresponding first group of one or more web servers and at least one second group of one or more user interfaces with access rights to content on at least one corresponding second group of one or more web servers.

18. The content distribution system of claim 11, wherein
at least one of the one or more user interfaces has access rights to content on a first group of one or more web servers and content on at least one second group of one or more web servers,
at least a portion of the content on the first group of one or more web servers is the same as at least a portion of the content on the at least one second group of one or more web servers, and
the at least one user interface executes computer-readable instructions to download only one instance of the content that is the same on the first group and second group(s) of one or more web servers.

19. The content distribution system of claim 11, wherein
the one or more web servers and the at least one second user interface are interconnected with each other over a secure computer network.

20. The content distribution system of claim 11, wherein
the one or more user interfaces comprise tablet PCs that wirelessly connect to the one or more web servers to download the content.
